(19) United States
(12) Patent Application Publication
(10) Pub. No.: US 2023/0084541 A1
(43) Pub. Date: Mar. 16, 2023

(54) COMPACT IMAGING OPTICS USING SPATIALLY LOCATED, FREE FORM OPTICAL COMPONENTS FOR DISTORTION COMPENSATION AND IMAGE CLARITY ENHANCEMENT

(71) Applicant: Meta Platforms Technologies, LLC, Menlo Park, CA (US)

(72) Inventors: Zhisheng YUN, Sammamish, WA (US); Brendan HAMEL-BISSELL, Bellevue, WA (US); Sascha HALLSTEIN, Saratoga, CA (US); Pavel TROCHTCHANOVITCH, Redmond, WA (US); Hyunmin SONG, Redmond, WA (US)

(73) Assignee: Meta Platforms Technologies, LLC, Menlo Park, CA (US)

(21) Appl. No.: 17/477,363

(22) Filed: Sep. 16, 2021

(51) Int. Cl. G02B 27/01; G02B 3/04

(52) U.S. Cl. CPC G02B 27/0172; G02B 3/04; G02B 2027/0178

(57) ABSTRACT

An optical assembly to enable distortion compensation and enhanced image clarity is provided. The optical assembly may include an optical stack, such as pancake optics. The optical assembly may also include at least two optical elements. The optical assembly may further include at least one spatially located, free form optical component between the at least two optical elements, wherein the spatially located, free form optical component provides distortion compensation and enhanced image clarity. In some examples, the spatially located, free form optical component may have a plurality of regions having different diffraction designs. In some examples, , the spatially located, free form optical component may also utilize a curvature (i.e., may have a curved surface) to implement a phase change profile that may provide distortion compensation.

### TECHNICAL FIELD

This patent application relates generally to optical lens design and configurations in optical systems, such as head-mounted displays (HMDs), and more specifically, to systems and methods for distortion compensation and image clarity enhancement using compact imaging optics with a spatially located, free form optical component located in a head-mounted display (HMD) or other optical device.

### BACKGROUND

Optical lens design and configurations are part of many modern-day devices, such as cameras used in mobile phones and various optical devices. One such optical device that relies on optical lens design is a head-mounted display (HMD). In some examples, a head-mounted display (HMD) may be a headset or eyewear used for video playback, gaming, or sports, and in a variety of contexts and applications, such as virtual reality (VR), augmented reality (AR), or mixed reality (MR).

Ideally, head-mounted displays (HMDs) utilize on lens designs or configurations that are lighter and less bulky. For instance, pancake optics are commonly used to provide a thinner profile in certain head-mounted displays (HMDs). However, conventional pancake optics may not provide an effective distortion compensation and image clarity enhancement features without requiring additional, dedicated optical components which may often increase weight, size, cost, and inefficiency.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a system associated with a head-mounted display (HMD), according to an example.

FIGS. 2A-2B illustrate various head-mounted displays (HMDs), in accordance with an example.

FIG. 3 illustrates a diagram of elements of an optical system including a spatially located, free form optical component, according to an example.

FIG. 4 illustrates a diagram of elements of an optical system including a spatially located, free form optical component, according to an example.

FIGS. 5A-C illustrate various arrangements and aspects of an optical device including a spatially located, free form optical component, according to an example.

FIG. 6 illustrates a diagram of an optical device including a spatially located, free form optical component, according to an example.

FIGS. 7A-C illustrate aspects of a phase change profile for a simple holographic optical element (HOE), according to examples.

FIGS. 8A-C illustrate aspects of a phase change profile for a curved holographic optical element (HOE), according to examples.

FIG. 9 illustrates a flow chart of a method for implementing a spatially located, free form optical component in an optical device for distortion compensation and clarity enhancement in an optical device, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

There are many types of optical devices that utilize optical design configurations. A head-mounted display (HMD) is an optical device that may communicate information to or from a user who is wearing a headset. For example, a virtual reality (VR) headset may be used to present visual information to simulate any number of virtual environments when worn by a user. The virtual reality (VR) headset may also receive information from the user’s eye movements, head/body shifts, voice, or other user-provided signals.

In many cases, optical lens design configurations seek to decrease headset size, weight, cost, and overall bulkiness. However, these attempts to provide a cost-effective device with a small form factor often limits the function of the head-mounted display (HMD). For example, while attempts to reduce the size and bulkiness of various optical configurations in conventional headsets can be achieved, this may often reduce the amount of space needed for other built-in features of a headset, thereby restricting or limiting a headset’s ability to function at full capacity.

In some aspects, pancake optics may typically be used to provide a thin profile or a lightweight design for head-mounted displays (HMDs) and other optical systems. However, conventional pancake optics, in attempting to provide a smaller form factor and thinner profile, may often fail in providing other important features. For instance, conventional pancake optics design can typically provide distortion compensation and image clarity enhancement only by using additional optical components, higher power consumption and/or increased mechanical movement, which may adversely affect cost, size, temperature, and/or other performance issues.

In some examples, a head-mounted display (HMD) or other optical system may include an eye-tracking unit to track an eyeball of a user. In some examples, the eye-tracking optical element may include a holographic optical element (HOE) that may utilized to “see” the eyeball of the user.

In some instances, during use, the eye-tracking unit may deviate and become rendered “off-axis.” In these instances, an image generated by the off-axis eye-tracking optical element may become distorted.

A first such distortion that may be exhibited by an image produced by an off-axis eye-tracking optical element may be a “keystone distortion.” So, in some examples, where an image may be projected onto a two-dimensional, square (or rectangular) “box” in front of the user’s eyeball, an off-axis eye-tracking optical element may produce an image that may not be appear as a square. Instead, a horizontal and vertical aspect ratio of the square (or rectangular) box may become mis-aligned (i.e., unbalanced), and image rendering on a horizontal plane may become (relatively) smaller while image rendering on a vertical plane may remain same. As a result, the image projected onto the square (or rectangular) box may appear trapezoidal.

Another such distortion that may be exhibited by an image produced by an off-axis eye-tracking optical element may be a “wavefront error.” A wavefront error may indicate a degree of deviation from a sharp-imaging, “ideal” wavefront seen when an optical ray may be transmitted or reflected through an optical component. In some examples, a planar wavefront error may be calculated as a degree of deviation seen in an ideal, collimated wavefront when a beam may be reflected off a perfectly flat planar surface.

The systems and methods described herein may provide a spatially located, free form optical component that may provide distortion compensation and image clarity enhancement using compact imaging optics. In some examples, the spatially located, free form optical component may include one or more of a free-form phase plate, a diffractive element, and/or a holographic optical element (HOE).

In some examples, a spatially located, free form optical component as described may be provided in an optical assembly of a head-mounted display (HMD) or other optical system. Moreover, as described herein, the spatially located, free form optical component, for example, may be provided in relation to optical components of pancake optics so that no significant or substantial increase in space may be required.

In some examples, a spatially located, free form optical component as described may be “free form,” in that it may take multiple physical shapes and/or forms. So, in some examples and as discussed further below, the spatially located, free form optical component may be curved in shape, while in other examples, one or more of the components of the spatially located, free form optical component may be linear in shape.

Accordingly, a spatially located, free form optical component as described may be utilized to adjust an unbalanced vertical and horizontal aspect ratio (e.g., caused by an off-axis eye-tracking unit), and may be able to counter distortion (e.g., a Keystone distortion). In some examples, the spatially located, free form optical component may utilize a curvature to implement a phase change in a phase profile. As a result, elements of a spatially located, free form optical component as described (e.g., a holographic optical element (HOE)) may enable generation of clearer, sharper images, which in some instances, may enable an optical camera to track an eyeball more effectively.

In some examples, the spatially located, free form optical component may be “spatially located” in that it may be particularly located within an optical system (e.g., a head-mounted display). As discussed further below, the spatially located, free form optical component may be located in one or more of multiple locations within the optical system in order to achieve particular imaging characteristics or meet particular imaging requirements. In some examples, a spatially located, free form optical component may enable both reflective and transmissive properties. That is, in some examples, a spatially located, free form optical component (e.g., a holographic optical element (HOE)) may be provided at a first location that may enable the spatially located, free form optical component to reflect optical rays (e.g., towards an eye box). In other examples, a spatially located, free form optical component may be implemented at a second location that may enable the spatially located, free form optical component to transmit optical rays.

In some examples, a spatially located, free form optical component as described may enable multiple views (i.e., “multi-view”) that may enable a camera to track an object (e.g., a viewing user’s eyeball) from multiple and different directions. More particularly, in some examples, the spatially located, free form optical components may be partitioned into multiple sections (i.e., regions) with specific and particular diffraction designs. In some examples, each of these plurality of regions with specific and particular diffraction designs may diffract incoming optical rays toward particular areas of an optical camera, which may enable the optical camera to perform like multiple cameras by tracking a viewing user’s eyeball from multiple, different directions.

Yet another advantage associated with a spatially located, free form optical component as described may be aberration compensation. In particular, spatially located, free form optical components described may counter various aberrations inherent in an optical system that may reduce quality of images produced by the optical system. One example of such an aberration may be spherical aberration, wherein a light ray that may strike a spherical surface off-center may be refracted or reflected more or less than those that strike close to the center.

As discussed in further detail below, in some examples, optimal performance of the spatially located, free form optical component may be achieved by optimizing physical aspects (e.g., curvature) and phase profiles of the spatially located, free form optical component as described. Indeed, in some examples, a spatially located, free form optical component may be used to enable an associated optical system to achieve higher resolution (e.g., <2.0 µm pixel size) compared to a typical optical system (e.g., <4.5-5.0 µm pixel size).

Accordingly, by providing a spatially located, free form optical component that is customizable in size, thickness, etc., the systems and methods described herein may provide a flexible and low-cost way to improve visual acuity without increasing size, thickness, cost, or overall bulkiness of the optical assembly. These and other examples will be described in more detail herein.

It should be appreciated that, in some examples, a spatially located, free form optical component may also serve or function as any number of optical components within an optical stack. For example, for curved optical components or windows in pancake optics, a spatially located, free form optical component as described may take on a “curved” shape and may also be placed within and/or among these non-flat components. In this way, use of one or more spatially located, free form optical components may minimize need for additional optics or currently existing optical components in pancake optics.

It should also be appreciated that the systems and methods described herein may be particularly suited for virtual reality (VR), augmented reality (AR), and/or mixed reality (MR) environments, but may also be applicable to a host of other systems or environments that include optical lens assemblies, e.g., those using pancake optics or other similar optical configurations. These may include, for example, cameras or sensors, networking, telecommunications, holography, or other optical systems. Thus, the optical configurations described herein, may be used in any of these or other examples. These and other benefits will be apparent in the description provided herein.

### System Overview

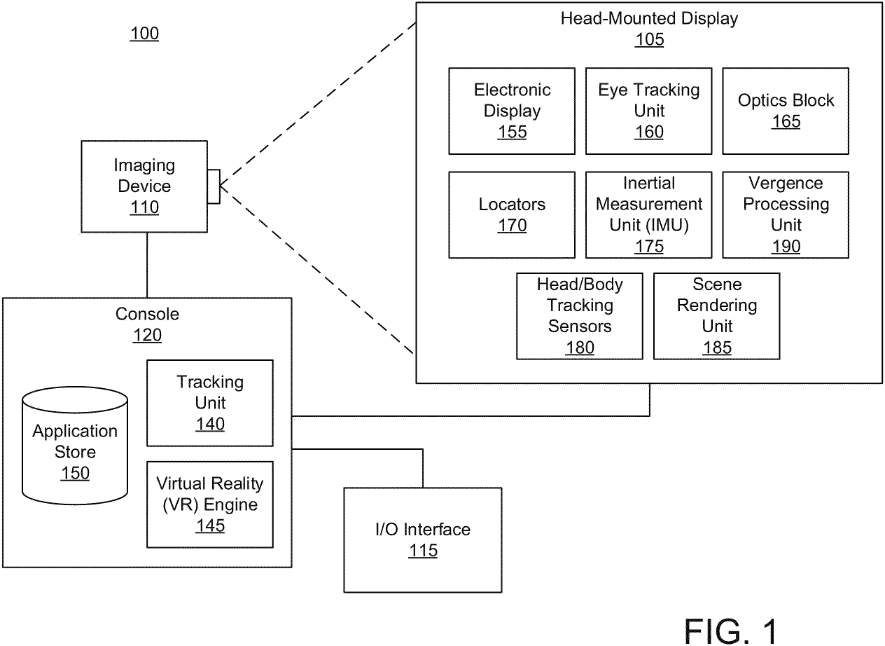

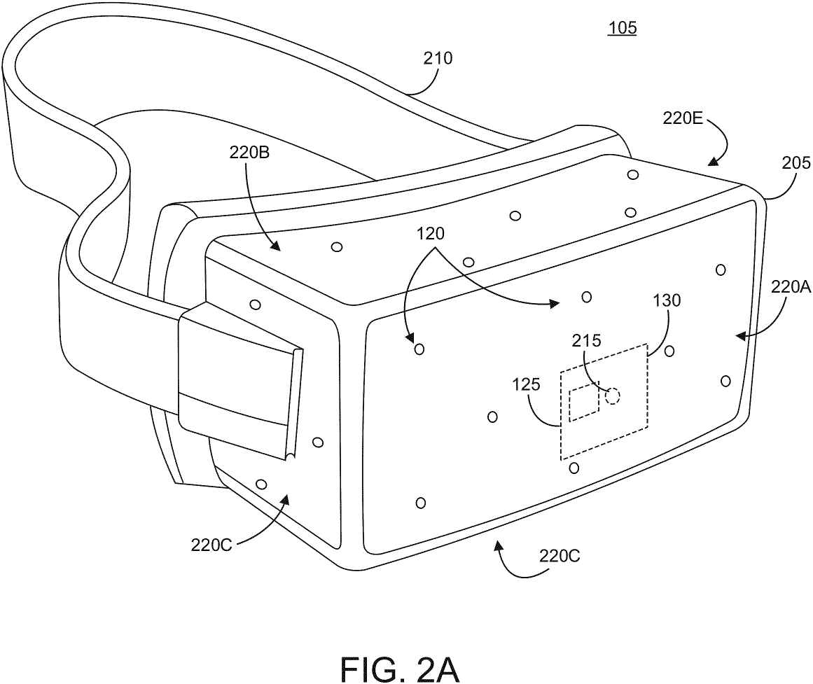

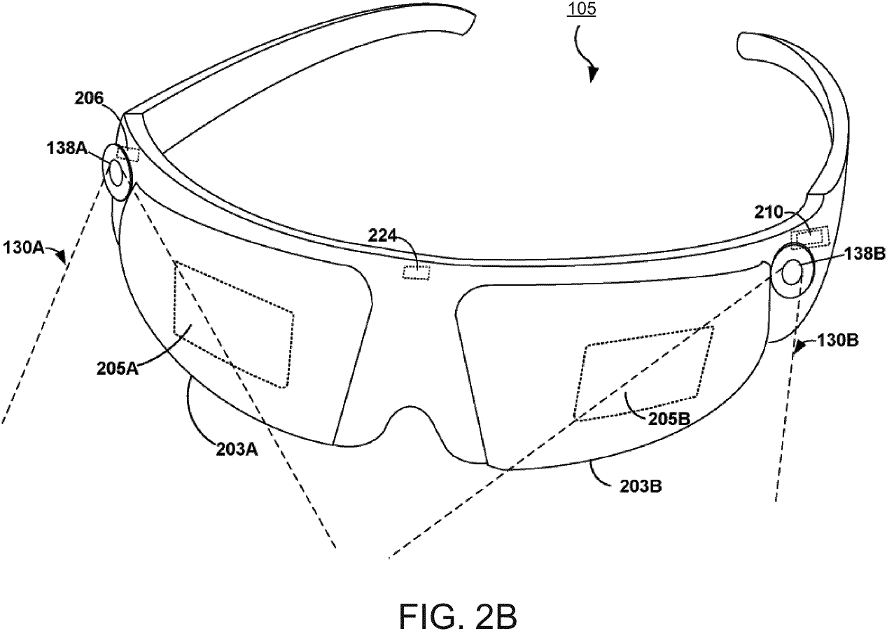

Reference is made to FIGS. 1 and 2A-2B. FIG. 1 illustrates a block diagram of a system 100 associated with a head-mounted display (HMD), according to an example. The system 100 may be used as a virtual reality (VR) system, an augmented reality (AR) system, a mixed reality (MR) system, or some combination thereof, or some other related system. It should be appreciated that the system 100 and the head-mounted display (HMD) 105 may be exemplary illustrations. Thus, the system 100 and/or the head-mounted display (HMD) 105 may or not include additional features and some of the features described herein may be removed and/or modified without departing from the scopes of the system 100 and/or the head-mounted display (HMD) 105 outlined herein.

In some examples, the system 100 may include the head-mounted display (HMD) 105, an imaging device 110, and an input/output (I/O) interface 115, each of which may be communicatively coupled to a console 120 or other similar device.

While FIG. 1 shows a single head-mounted display (HMD) 105, a single imaging device 110, and an I/O interface 115, it should be appreciated that any number of these components may be included in the system 100. For example, there may be multiple head-mounted displays (HMDs) 105, each having an associated input interface 115 and being monitored by one or more imaging devices 110, with each head-mounted display (HMD) 105, I/O interface 115, and imaging devices 110 communicating with the console 120. In alternative configurations, different and/or additional components may also be included in the system 100. As described herein, the head-mounted display (HMD) 105 may act be used as a virtual reality (VR), augmented reality (AR), and/or a mixed reality (MR) head-mounted display (HMD). A mixed reality (MR) and/or augmented reality (AR) head-mounted display (HMD), for instance, may augment views of a physical, real-world environment with computer-generated elements (e.g., images, video, sound, etc.).

The head-mounted display (HMD) 105 may communicate information to or from a user who is wearing the headset. In some examples, the head-mounted display (HMD) 105 may provide content to a user, which may include, but not limited to, images, video, audio, or some combination thereof. In some examples, audio content may be presented via a separate device (e.g., speakers and/or headphones) external to the head-mounted display (HMD) 105 that receives audio information from the head-mounted display (HMD) 105, the console 120, or both. In some examples, the head-mounted display (HMD) 105 may also receive information from a user. This information may include eye moments, head/body movements, voice (e.g., using an integrated or separate microphone device), or other user-provided content.

The head-mounted display (HMD) 105 may include any number of components, such as an electronic display 155, an eye tracking unit 160, an optics block 165, one or more locators 170, an inertial measurement unit (IMU) 175, one or head/body tracking sensors 180, and a scene rendering unit 185, and a vergence processing unit 190.

While the head-mounted display (HMD) 105 described in FIG. 1 is generally within a VR context as part of a VR system environment, the head-mounted display (HMD) 105 may also be part of other HMD systems such as, for example, an AR system environment. In examples that describe an AR system or MR system environment, the head-mounted display (HMD) 105 may augment views of a physical, real-world environment with computer-generated elements (e.g., images, video, sound, etc.).

An example of the head-mounted display (HMD) 105 is further described below in conjunction with FIG. 2. The head-mounted display (HMD) 105 may include one or more rigid bodies, which may be rigidly or non-rigidly coupled to each other together. A rigid coupling between rigid bodies causes the coupled rigid bodies to act as a single rigid entity. In contrast, a non-rigid coupling between rigid bodies allows the rigid bodies to move relative to each other.

The electronic display 155 may include a display device that presents visual data to a user. This visual data may be transmitted, for example, from the console 120. In some examples, electronic display 155 may also present tracking light for tracking the user’s eye movements. It should be appreciated that the electronic display 155 may include any number of electronic display elements (e.g., a display for each of the user). Examples of a display device that may be used in the electronic display 155 may include, but not limited to a liquid crystal display (LCD), a light emitting diode (LED), an organic light emitting diode (OLED) display, an active-matrix organic light-emitting diode (AMOLED) display, micro light emitting diode (micro-LED) display, some other display, or some combination thereof.

The optics block 165 may adjust its focal length based on or in response to instructions received from the console 120 or other component. In some examples, the optics block 165 may include a multi multifocal block to adjust a focal length (adjusts optical power) of the optics block 165.

The eye tracking unit 160 may track an eye position and eye movement of a user of the head-mounted display (HMD) 105. A camera or other optical sensor inside the head-mounted display (HMD) 105 may capture image information of a user’s eyes, and the eye tracking unit 160 may use the captured information to determine interpupillary distance, interocular distance, a three-dimensional (3D) position of each eye relative to the head-mounted display (HMD) 105 (e.g., for distortion adjustment purposes), including a magnitude of torsion and rotation (i.e., roll, pitch, and yaw) and gaze directions for each eye. The information for the position and orientation of the user’s eyes may be used to determine the gaze point in a virtual scene presented by the head-mounted display (HMD) 105 where the user is looking.

The vergence processing unit 190 may determine a vergence depth of a user’s gaze. In some examples, this may be based on the gaze point or an estimated intersection of the gaze lines determined by the eye tracking unit 160. Vergence is the simultaneous movement or rotation of both eyes in opposite directions to maintain single binocular vision, which is naturally and/or automatically performed by the human eye. Thus, a location where a user’s eyes are verged may refer to where the user is looking and may also typically be the location where the user’s eyes are focused. For example, the vergence processing unit 190 may triangulate the gaze lines to estimate a distance or depth from the user associated with intersection of the gaze lines. The depth associated with intersection of the gaze lines can then be used as an approximation for the accommodation distance, which identifies a distance from the user where the user’s eyes are directed. Thus, the vergence distance allows determination of a location where the user’s eyes should be focused.

The one or more locators 170 may be one or more objects located in specific positions on the head-mounted display (HMD) 105 relative to one another and relative to a specific reference point on the head-mounted display (HMD) 105. A locator 170, in some examples, may be a light emitting diode (LED), a corner cube reflector, a reflective marker, and/or a type of light source that contrasts with an environment in which the head-mounted display (HMD) 105 operates, or some combination thereof. Active locators 170 (e.g., an LED or other type of light emitting device) may emit light in the visible band (Au380 nm to 850 nm), in the infrared (IR) band (Àú850 nm to 1 mm), in the ultraviolet band (10 nm to 380 nm), some other portion of the electromagnetic spectrum, or some combination thereof.

The one or more locators 170 may be located beneath an outer surface of the head-mounted display (HMD) 105, which may be transparent to wavelengths of light emitted or reflected by the locators 170 or may be thin enough not to substantially attenuate wavelengths of light emitted or reflected by the locators 170. Further, the outer surface or other portions of the head-mounted display (HMD) 105 may be opaque in the visible band of wavelengths of light. Thus, the one or more locators 170 may emit light in the IR band while under an outer surface of the head-mounted display (HMD) 105 that may be transparent in the IR band but opaque in the visible band.

The inertial measurement unit (IMU) 175 may be an electronic device that generates, among other things, fast calibration data based on or in response to measurement signals received from one or more of the head/body tracking sensors 180, which may generate one or more measurement signals in response to motion of head-mounted display (HMD) 105. Examples of the head/body tracking sensors 180 may include, but not limited to, accelerometers, gyroscopes, magnetometers, cameras, other sensors suitable for detecting motion, correcting error associated with the inertial measurement unit (IMU) 175, or some combination thereof. The head/body tracking sensors 180 may be located external to the inertial measurement unit (IMU) 175, internal to the inertial measurement unit (IMU) 175, or some combination thereof.

Based on or in response to the measurement signals from the head/body tracking sensors 180, the inertial measurement unit (IMU) 175 may generate fast calibration data indicating an estimated position of the head-mounted display (HMD) 105 relative to an initial position of the head-mounted display (HMD) 105. For example, the head/body tracking sensors 180 may include multiple accelerometers to measure translational motion (forward/back, up/down, left/right) and multiple gyroscopes to measure rotational motion (e.g., pitch, yaw, and roll). The inertial measurement unit (IMU) 175 may then, for example, rapidly sample the measurement signals and/or calculate the estimated position of the head-mounted display (HMD) 105 from the sampled data. For example, the inertial measurement unit (IMU) 175 may integrate measurement signals received from the accelerometers over time to estimate a velocity vector and integrates the velocity vector over time to determine an estimated position of a reference point on the head-mounted display (HMD) 105. It should be appreciated that the reference point may be a point that may be used to describe the position of the head-mounted display (HMD) 105. While the reference point may generally be defined as a point in space, in various examples or scenarios, a reference point as used herein may be defined as a point within the head-mounted display (HMD) 105 (e.g., a center of the inertial measurement unit (IMU) 175). Alternatively or additionally, the inertial measurement unit (IMU) 175 may provide the sampled measurement signals to the console 120, which may determine the fast calibration data or other similar or related data.

The inertial measurement unit (IMU) 175 may additionally receive one or more calibration parameters from the console 120. As described herein, the one or more calibration parameters may be used to maintain tracking of the head-mounted display (HMD) 105. Based on a received calibration parameter, the inertial measurement unit (IMU) 175 may adjust one or more of the IMU parameters (e.g., sample rate). In some examples, certain calibration parameters may cause the inertial measurement unit (IMU) 175 to update an initial position of the reference point to correspond to a next calibrated position of the reference point. Updating the initial position of the reference point as the next calibrated position of the reference point may help reduce accumulated error associated with determining the estimated position. The accumulated error, also referred to as drift error, may cause the estimated position of the reference point to “drift” away from the actual position of the reference point over time.

The scene rendering unit 185 may receive content for the virtual scene from a VR engine 145 and may provide the content for display on the electronic display 155. Additionally or alternatively, the scene rendering unit 185 may adjust the content based on information from the inertial measurement unit (IMU) 175, the vergence processing unit 830, and/or the head/body tracking sensors 180. The scene rendering unit 185 may determine a portion of the content to be displayed on the electronic display 155 based at least in part on one or more of the tracking unit 140, the head/body tracking sensors 180, and/or the inertial measurement unit (IMU) 175.

The imaging device 110 may generate slow calibration data in accordance with calibration parameters received from the console 120. Slow calibration data may include one or more images showing observed positions of the locators 125 that are detectable by imaging device 110. The imaging device 110 may include one or more cameras, one or more video cameras, other devices capable of capturing images including one or more locators 170, or some combination thereof. Additionally, the imaging device 110 may include one or more filters (e.g., for increasing signal to noise ratio). The imaging device 110 may be configured to detect light emitted or reflected from the one or more locators 170 in a field of view of the imaging device 110. In examples where the locators 170 include one or more passive elements (e.g., a retroreflector), the imaging device 110 may include a light source that illuminates some or all of the locators 170, which may retro-reflect the light towards the light source in the imaging device 110. Slow calibration data may be communicated from the imaging device 110 to the console 120, and the imaging device 110 may receive one or more calibration parameters from the console 120 to adjust one or more imaging parameters (e.g., focal length, focus, frame rate, ISO, sensor temperature, shutter speed, aperture, etc.).

The I/O interface 115 may be a device that allows a user to send action requests to the console 120. An action request may be a request to perform a particular action. For example, an action request may be to start or end an application or to perform a particular action within the application. The I/O interface 115 may include one or more input devices. Example input devices may include a keyboard, a mouse, a hand-held controller, a glove controller, and/or any other suitable device for receiving action requests and communicating the received action requests to the console 120. An action request received by the I/O interface 115 may be communicated to the console 120, which may perform an action corresponding to the action request. In some examples, the I/O interface 115 may provide haptic feedback to the user in accordance with instructions received from the console 120. For example, haptic feedback may be provided by the I/O interface 115 when an action request is received, or the console 120 may communicate instructions to the I/O interface 115 causing the I/O interface 115 to generate haptic feedback when the console 120 performs an action.

The console 120 may provide content to the head-mounted display (HMD) 105 for presentation to the user in accordance with information received from the imaging device 110, the head-mounted display (HMD) 105, or the I/O interface 115. The console 120 includes an application store 150, a tracking unit 140, and the VR engine 145. Some examples of the console 120 have different or additional units than those described in conjunction with FIG. 1. Similarly, the functions further described below may be distributed among components of the console 120 in a different manner than is described here.

The application store 150 may store one or more applications for execution by the console 120, as well as other various application-related data. An application, as used herein, may refer to a group of instructions, that when executed by a processor, generates content for presentation to the user. Content generated by an application may be in response to inputs received from the user via movement of the head-mounted display (HMD) 105 or the I/O interface 115. Examples of applications may include gaming applications, conferencing applications, video playback application, or other applications.

The tracking unit 140 may calibrate the system 100. This calibration may be achieved by using one or more calibration parameters and may adjust one or more calibration parameters to reduce error in determining position of the head-mounted display (HMD) 105. For example, the tracking unit 140 may adjust focus of the imaging device 110 to obtain a more accurate position for observed locators 170 on the head-mounted display (HMD) 105. Moreover, calibration performed by the tracking unit 140 may also account for information received from the inertial measurement unit (IMU) 175. Additionally, if tracking of the head-mounted display (HMD) 105 is lost (e.g., imaging device 110 loses line of sight of at least a threshold number of locators 170), the tracking unit 140 may re-calibrate some or all of the system 100 components.

Additionally, the tracking unit 140 may track the movement of the head-mounted display (HMD) 105 using slow calibration information from the imaging device 110 and may determine positions of a reference point on the head-mounted display (HMD) 105 using observed locators from the slow calibration information and a model of the head-mounted display (HMD) 105. The tracking unit 140 may also determine positions of the reference point on the head-mounted display (HMD) 105 using position information from the fast calibration information from the inertial measurement unit (IMU) 175 on the head-mounted display (HMD) 105. Additionally, the eye tracking unit 160 may use portions of the fast calibration information, the slow calibration information, or some combination thereof, to predict a future location of the head-mounted display (HMD) 105, which may be provided to the VR engine 145.

The VR engine 145 may execute applications within the system 100 and may receive position information, acceleration information, velocity information, predicted future positions, other information, or some combination thereof for the head-mounted display (HMD) 105 from the tracking unit 140 or other component. Based on or in response to the received information, the VR engine 145 may determine content to provide to the head-mounted display (HMD) 105 for presentation to the user. This content may include, but not limited to, a virtual scene, one or more virtual objects to overlay onto a real world scene, etc.

In some examples, the VR engine 145 may maintain focal capability information of the optics block 165. Focal capability information, as used herein, may refer to information that describes what focal distances are available to the optics block 165. Focal capability information may include, e.g., a range of focus the optics block 165 is able to accommodate (e.g., 0 to 4 diopters), a resolution of focus (e.g., 0.25 diopters), a number of focal planes, combinations of settings for switchable half wave plates (SHWPs) (e.g., active or non-active) that map to particular focal planes, combinations of settings for SHWPS and active liquid crystal lenses that map to particular focal planes, or some combination thereof.

The VR engine 145 may generate instructions for the optics block 165. These instructions may cause the optics block 165 to adjust its focal distance to a particular location. The VR engine 145 may generate the instructions based on focal capability information and, e.g., information from the vergence processing unit 190, the inertial measurement unit (IMU) 175, and/or the head/body tracking sensors 180. The VR engine 145 may use information from the vergence processing unit 190, the inertial measurement unit (IMU) 175, and the head/body tracking sensors 180, other source, or some combination thereof, to select an ideal focal plane to present content to the user. The VR engine 145 may then use the focal capability information to select a focal plane that is closest to the ideal focal plane. The VR engine 145 may use the focal information to determine settings for one or more SHWPs, one or more active liquid crystal lenses, or some combination thereof, within the optics block 176 that are associated with the selected focal plane. The VR engine 145 may generate instructions based on the determined settings, and may provide the instructions to the optics block 165.

The VR engine 145 may perform any number of actions within an application executing on the console 120 in response to an action request received from the I/O interface 115 and may provide feedback to the user that the action was performed. The provided feedback may be visual or audible feedback via the head-mounted display (HMD) 105 or haptic feedback via the I/O interface 115.

FIGS. 2A-2B illustrate various head-mounted displays (HMDs), in accordance with an example. FIG. 2A shows a head-mounted display (HMD) 105, in accordance with an example. The head-mounted display (HMD) 105 may include a front rigid body 205 and a band 210. The front rigid body 205 may include an electronic display (not shown), an inertial measurement unit (IMU) 175, one or more position sensors (e.g., head/body tracking sensors 180), and one or more locators 170, as described herein. In some examples, a user movement may be detected by use of the inertial measurement unit (IMU) 175, position sensors (e.g., head/body tracking sensors 180), and/or the one or more locators 170, and an image may be presented to a user through the electronic display based on or in response to detected user movement. In some examples, the head-mounted display (HMD) 105 may be used for presenting a virtual reality, an augmented reality, or a mixed reality environment.

At least one position sensor, such as the head/body tracking sensor 180 described with respect to FIG. 1, may generate one or more measurement signals in response to motion of the head-mounted display (HMD) 105. Examples of position sensors may include: one or more accelerometers, one or more gyroscopes, one or more magnetometers, another suitable type of sensor that detects motion, a type of sensor used for error correction of the inertial measurement unit (IMU) 175, or some combination thereof. The position sensors may be located external to the inertial measurement unit (IMU) 175, internal to the inertial measurement unit (IMU) 175, or some combination thereof. In FIG. 2A, the position sensors may be located within the inertial measurement unit (IMU) 175, and neither the inertial measurement unit (IMU) 175 nor the position sensors (e.g., head/body tracking sensors 180) may or may not necessarily be visible to the user.

Based on the one or more measurement signals from one or more position sensors, the inertial measurement unit (IMU) 175 may generate calibration data indicating an estimated position of the head-mounted display (HMD) 105 relative to an initial position of the head-mounted display (HMD) 105. In some examples, the inertial measurement unit (IMU) 175 may rapidly sample the measurement signals and calculates the estimated position of the HMD 105 from the sampled data. For example, the inertial measurement unit (IMU) 175 may integrate the measurement signals received from the one or more accelerometers (or other position sensors) over time to estimate a velocity vector and integrates the velocity vector over time to determine an estimated position of a reference point on the head-mounted display (HMD) 105. Alternatively or additionally, the inertial measurement unit (IMU) 175 may provide the sampled measurement signals to a console (e.g., a computer), which may determine the calibration data. The reference point may be a point that may be used to describe the position of the head-mounted display (HMD) 105. While the reference point may generally be defined as a point in space; however, in practice, the reference point may be defined as a point within the head-mounted display (HMD) 105 (e.g., a center of the inertial measurement unit (IMU) 175).

One or more locators 170, or portions of locators 170, may be located on a front side 220A, a top side 220B, a bottom side 220C, a right side 220D, and a left side 220E of the front rigid body 205 in the example of FIG. 2. The one or more locators 170 may be located in fixed positions relative to one another and relative to a reference point 215. In FIG. 2, the reference point 215, for example, may be located at the center of the inertial measurement unit (IMU) 175. Each of the one or more locators 170 may emit light that is detectable by an imaging device (e.g., camera or an image sensor).

FIG. 2B illustrates a head-mounted displays (HMDs), in accordance with another example. As shown in FIG. 2B, the head-mounted display (HMD) 105 may take the form of a wearable, such as glasses. The head-mounted display (HMD) 105 of FIG. 2B may be another example of the head-mounted display (HMD) 105 of FIG. 1. The head-mounted display (HMD) 105 may be part of an artificial reality (AR) system, or may operate as a stand-alone, mobile artificial realty system configured to implement the techniques described herein.

In some examples, the head-mounted display (HMD) 105 may be glasses comprising a front frame including a bridge to allow the head-mounted display (HMD) 105 to rest on a user’s nose and temples (or “arms”) that extend over the user’s ears to secure the head-mounted display (HMD) 105 to the user. In addition, the head-mounted display (HMD) 105 of FIG. 2B may include one or more interior-facing electronic displays 203A and 203B (collectively, “electronic displays 203”) configured to present artificial reality content to a user and one or more varifocal optical systems 205A and 205B (collectively, “varifocal optical systems 205”) configured to manage light output by interior-facing electronic displays 203. In some examples, a known orientation and position of display 203 relative to the front frame of the head-mounted display (HMD) 105 may be used as a frame of reference, also referred to as a local origin, when tracking the position and orientation of the head-mounted display (HMD) 105 for rendering artificial reality (AR) content, for example, according to a current viewing perspective of the head-mounted display (HMD) 105 and the user.

As further shown in FIG. 2B, the head-mounted display (HMD) 105 may further include one or more motion sensors 206, one or more integrated image capture devices 138A and 138B (collectively, “image capture devices 138”), an internal control unit 210, which may include an internal power source and one or more printed-circuit boards having one or more processors, memory, and hardware to provide an operating environment for executing programmable operations to process sensed data and present artificial reality content on display 203. These components may be local or remote, or a combination thereof.

Although depicted as separate components in FIG. 1, it should be appreciated that the head-mounted display (HMD) 105, the imaging device 110, the I/O interface 115, and the console 120 may be integrated into a single device or wearable headset. For example, this single device or wearable headset (e.g., the head-mounted display (HMD) 105 of FIGS. 2A-2B) may include all the performance capabilities of the system 100 of FIG. 1 within a single, self-contained headset. Also, in some examples, tracking may be achieved using an “inside-out” approach, rather than an “outside-in” approach. In an “inside-out” approach, an external imaging device 110 or locators 170 may not be needed or provided to system 100. Moreover, although the head-mounted display (HMD) 105 is depicted and described as a “headset,” it should be appreciated that the head-mounted display (HMD) 105 may also be provided as eyewear or other wearable device (on a head or other body part), as shown in FIG. 2A. Other various examples may also be provided depending on use or application.

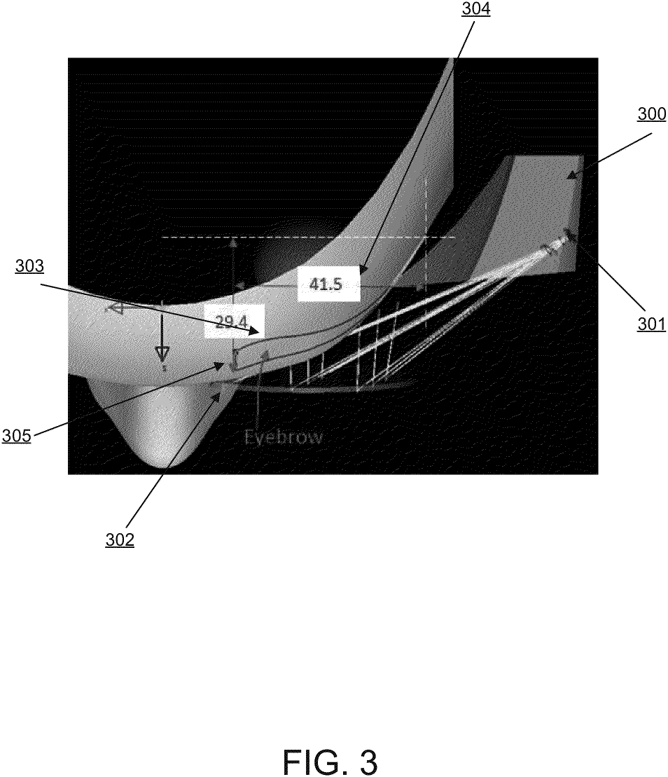

FIG. 3 illustrates a diagram of elements of an optical system including a spatially located, free form optical component. In some examples, the optical system 300 may be a head-mounted display (HMD). Also, in some examples, the optical system 300 may include an optical camera 301 and a spatially located, free form optical component 302. In some examples, the spatially located, free form optical component 302 may be a holographic optical element (HOE). In some examples, the spatially located, free form optical component 302 may include any number of free form optical components. In some examples, the free form optical component 302 may be included in the optical camera 301.

In some examples, the optical camera 301 may project light rays (as shown) to reflect off of the spatially located, free form optical component 302. Moreover, in some examples, the optical camera 301 may utilize the reflected light rays to track (i.e., “see”) movement, including movement of an eyeball (not shown) and an eyebrow 305 of a viewing user. As indicated, in some examples, the optical camera 301 may track movement over a particular length 303 (e.g., 29.4 millimeters (mm)) and over a particular width 304 (e.g., 41.5 millimeters (mm))

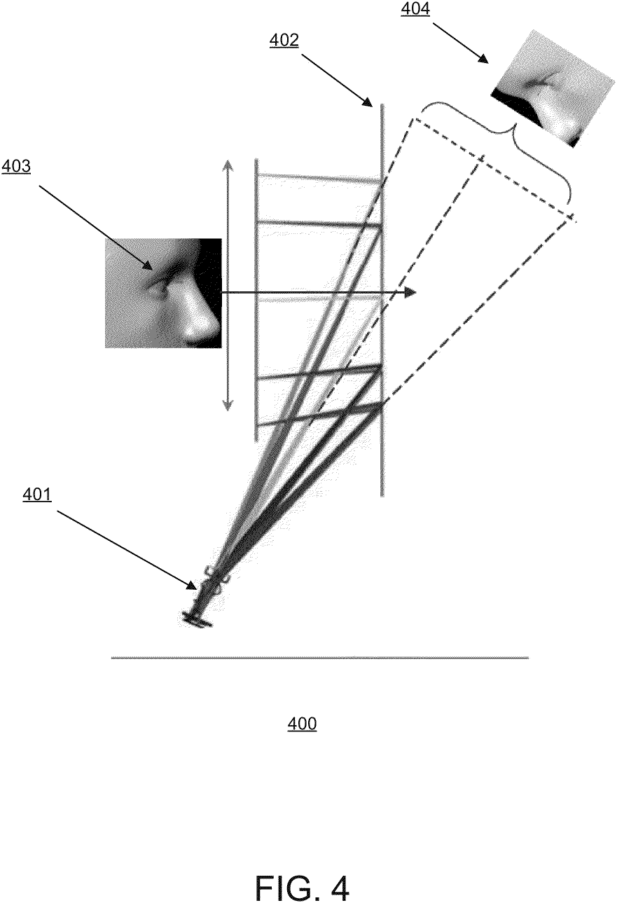

FIG. 4 illustrates a diagram of elements of an optical system including a spatially located, free form optical component. Similar to the example illustrated in FIG. 3, the optical system 400 may include a an optical camera 401 and a spatially located, free form optical component 402. In some examples, the spatially located, free form optical component 402 may be a holographic optical element (HOE). So, in some examples, the optical camera 402 may transmit optical rays toward the spatially located, free form optical component 401 to be reflected toward a viewing eyeball plane (or “eye box”) 403 in order to generate a reflected image 404. In some examples, the reflected image 404 may be used to, among other things, track the viewing user’s eyeball 403. Also, in some examples, the spatially located, free form optical component 401 may be independent from the optical camera 402, while in other examples the spatially located, free form optical component 401 may be included as part of the optical camera 402. In some examples, the spatially located, free form optical component 401 may have, in addition to a particular width and height, a minimal thickness that may enable the spatially located, free form optical component 401 to be located in an optical assembly.

### Multiple View (“Multi-View”) Configurations of a Spatially Located, Free Form Optical Component

Typically, an optical camera may transmit optical rays onto an optical element (e.g., a holographic optical element (HOE)), wherein various colors (e.g., red, green, yellow and blue) associated with the transmitted optical rays may be transmitted together (i.e., merged). Accordingly, in these instances, an optical camera in utilizing the merged optical rays, may only track a viewing user’s eyeball from one (merged) direction, and may only be able to provide on one “view” of a viewing user’s eyeball.

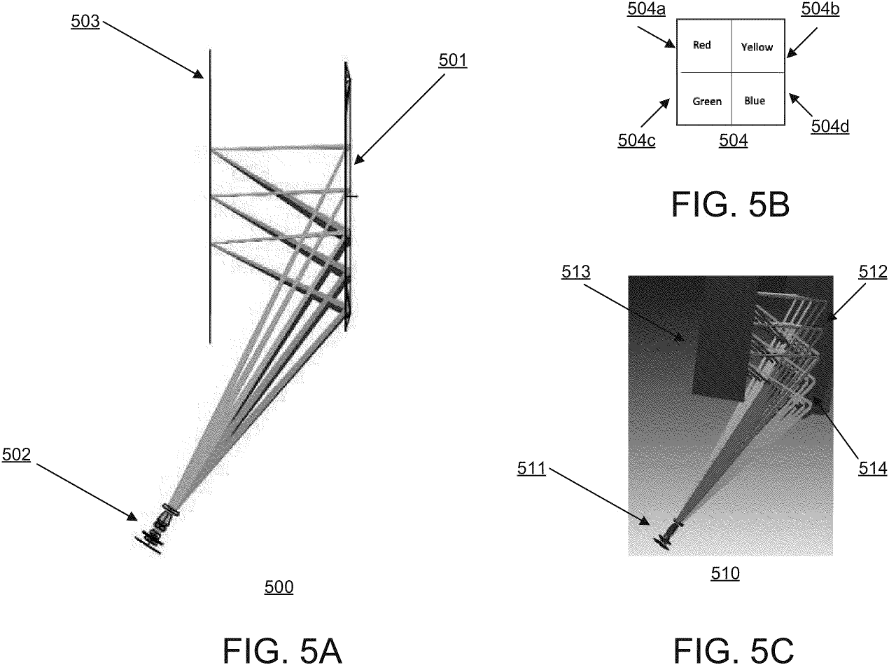

However, in some examples, a spatially located, free form optical component as described may provide multiple views (i.e., “multi-view”) that may enable a camera to track a human user’s eyeball from multiple and different directions. FIGS. 5A-C illustrate various arrangements and aspects of an optical device (e.g., a head-mounted display) including a spatially located, free form optical component.

In some examples and as illustrated in FIG. 5A, an optical system 500 may include an optical camera 502. In some instances, the optical camera 502 may transmit optical rays towards a spatially located, free form optical component 501. In these instances, the optical rays may be reflected off the spatially located, free form optical component 501 toward an viewing plane, like a pupil plane 503, wherein the reflected rays may be analyzed (e.g., by a computer software) to track a user’s eyeball. In some examples, the spatially located, free form optical component 501 may be a holographic optical element (HOE).

In some examples, to provide multiple views (i.e., a “multi-view”) that may enable a camera to track an object (e.g., a viewing user’s eyeball) from multiple and different directions, the spatially located, free form optical component 501 may be partitioned into multiple sections (i.e., regions). In particular, a surface of the spatially located, free form optical component 501 may be partitioned into a plurality of regions with specific and particular diffraction designs. In one example, each of the specific and particular diffraction designs of the plurality of regions may be unique.

In some examples, each of these plurality of regions associated with specific and particular diffraction designs may diffract incoming optical rays at particular “viewing” angles. As used herein, a “viewing angle” or “reflective angle” may include any angle that at an incoming optical ray may be reflected from a surface of a spatially located, free form optical component, as described. So, in some examples, each of the plurality of regions with specific and/or unique diffraction designs may enable one of a plurality of “clustered” optical rays to be reflected from the eyeball plane (back) at a particular viewing angle and toward the optical camera 502 for capture, for example, at a specific segment of an associated sensor. Also, in some examples, each of the multiple clusters of optical rays may be captured by the optical camera 502 with a corresponding segment of an associated sensor, and may be analyzed (e.g., via computer software). In this manner, the optical camera 502 may be enabled to perform like multiple cameras by tracking a viewing user’s eyeball from multiple, different directions. Moreover, in some instances, this may enable determining (e.g., via computer software) of a gazing angle of a viewing user’s eyeball more accurately as well.

An example of a surface of a spatially located, free form optical component 504 including a plurality of regions with particular and/or unique diffraction designs is illustrated in FIG. 5B. In some examples, the spatially located, free form optical component 504 may be a holographic optical element (HOE). So, in some examples, the spatially located, free form optical component 504 may include a plurality of regions 504a-d having specific and particular diffraction designs. In some examples, the first region 504a may be designed to diffract red optical rays (i.e., a red cluster), the second region 504b may be designed to diffract yellow optical rays (i.e., a yellow cluster), the third region 504c may be designed to diffract green optical rays (i.e., a green cluster), and the fourth region 504d may be designed to diffract blue optical rays (i.e., a blue cluster).

In some examples, and as shown in the example illustrated in FIG. 5C, an optical system 510 may include an optical camera 511 and a spatially located, free form optical component 512, wherein the spatially located, free form optical component 512 may include a plurality of regions (e.g., similar to the plurality of regions 504a-d) having specific and particular diffraction designs that may diffract a red cluster, a yellow cluster, a green cluster, and a blue cluster of optical rays at different (i.e., unique), particular viewing angles. In some examples, the optical camera 511 may receive each of the red cluster, the yellow cluster, green cluster and blue cluster of optical rays from each of the plurality of regions on spatially located, free form optical component 512. In these examples, the received optical rays may be analyzed (e.g., via a computer software) to track an object (e.g., an eyeball) from a plurality of directions (i.e., “multi-view”). In some examples, these multi-view features of a spatially located, free form optical component as described may be utilized to mitigate eyelash occlusion as well.

### Through-The-Lens (TTL) Configurations for Spatially Located, Free Form Optical component

In some examples and as described above, a spatially located, free form optical component may be implemented as a reflective element. For example and as discussed above, in the examples illustrated in FIGS. 4 and 5A-C, a spatially located, free form optical component (e.g., a holographic optical element (HOE)) may reflect optical rays from an optical camera to track a viewing user’s eyeball. However, as described further below, in various examples, a “spatially located,” free form optical component may be located in any one of multiple and/or various locations in relation to other components in an optical device to achieve particular optical characteristics.

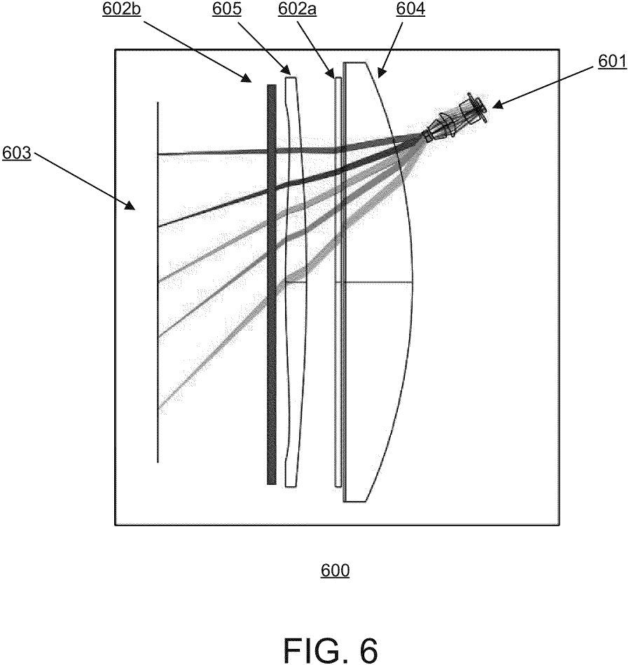

FIG. 6 illustrates a diagram of an optical device including a spatially located, free form optical component. In some examples, the optical system 600 may include an optical camera 601, a spatially located, free form optical component 602, a first viewing optics element 604 and a second viewing optics element 605. In some examples, the optical camera 601 may transmit optical rays toward the spatially located, free form optical component 602. Moreover, in some examples, the spatially located, free form optical component 602 may be a holographic optical element (HOE).

So, in some examples, the spatially located, free form optical component 601 may be located at a first location 602a (i.e., a transmissive location), wherein the spatially located, free form optical component 602 may be utilized as a transmissive element. In particular, the spatially located, free form optical component 602, when located at the first location 602a, may enable transmitted optical rays to travel through and toward a viewing plane 603. So, in some examples, the spatially located, free form optical component 602 may be utilized in a augmented reality (AR) context, for example, to modify or enhance a viewed image.

In addition, in some examples, the spatially located, free form optical component 602 may be located in a second location 602b (i.e., a reflective location), wherein the spatially located, free form optical component 602 may be utilized as a reflector element. In some examples, the spatially located, free form optical component 602, when located at the second location 602b, may enable transmitted optical rays to track an eyeball via a viewing plane 603. So, in some examples, the spatially located, free form optical component 602 may be utilized in a virtual reality (VR) context, for example, to track an eyeball of a viewing user. In examples implementing multi-view configurations, the optical component 602, when located at the first location 602a and the second location 602b, may be divided into multiple segments that may collect clusters of optical rays at multiple viewing angle such that each cluster of optical rays at an viewing angle may arrive at corresponding section on a sensor of the optical camera 601. Moreover, in some examples, a computer program may be utilized to process data associated with each cluster of optical rays at a multiple viewing angle separately.

It should be appreciated that although the examples described herein utilize the first location 602a and the second location 602b for the free form optical component 602, other locations for the free form optical component may be utilized as well. Moreover, it should be appreciated that these locations may be adjusted as well from a first location (e.g., the first location 602a) to a second location (e.g., the second location 602b) as may be determined (e.g., via a computer software).

It should be appreciated that the spatially located, free form optical component 602 may enable multi-view capabilities discussed above in any of the various locations in relation to other components in an optical device, including the first location 602a and the second location 602b. That is, in some examples, the spatially located, free form optical component 602 may be partitioned into multiple regions with specific and particular diffraction designs, and may enable tracking of an object (e.g., an eyeball) from multiple directions.

### Free Form Aspects of a Spatially Located, Free Form Optical Component

In some examples and as described above, a spatially located, free form optical component may be “free form,” in that may take various physical forms (i.e., shapes). For example, as discussed above, in some examples, the spatially located, free form optical component may be a holographic optical element (HOE) that may have a linear (i.e., straight) surface. In other examples, the spatially located, free form optical component may be a holographic optical element (HOE) that may have a curved surface.

In some examples, a form (e.g., curvature) of a spatially located, free form optical component be associated with a particular phase profile. That is, in some examples, the spatially located, free form optical component (e.g., a holographic optical element (HOE)) may reflect optical rays according to a particular phase profile.

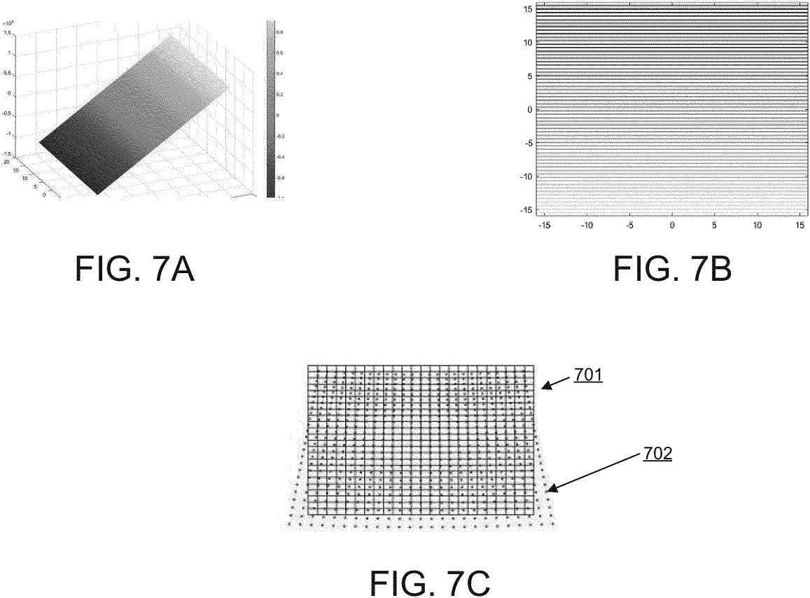

In some examples, a spatially located, free form optical component (e.g., holographic optical element (HOE)) may implement a phase profile that may provide gradual phase change. In some instances, the gradual phase change may be a linear phase change. FIGS. 7A-C illustrate aspects of a phase change profile for a simple holographic optical element (HOE). As illustrated in FIGS. 7A & 7B, the linear phase change may be evidenced by a linear gradient on a phase change profile.

However, it should be appreciated that, in some examples, a linear phase change profile may result in an optical element (e.g., a holographic optical element (HOE)) delivering a distorted image. Specifically, as shown in FIG. 7C, when an image 701 having a rectangular shape may be projected, the distorted version of the image 702 may appear to have a trapezoidal shape. As such, implementation of a gradual or linear phase change may result in a Keystone distortion (as discussed above).

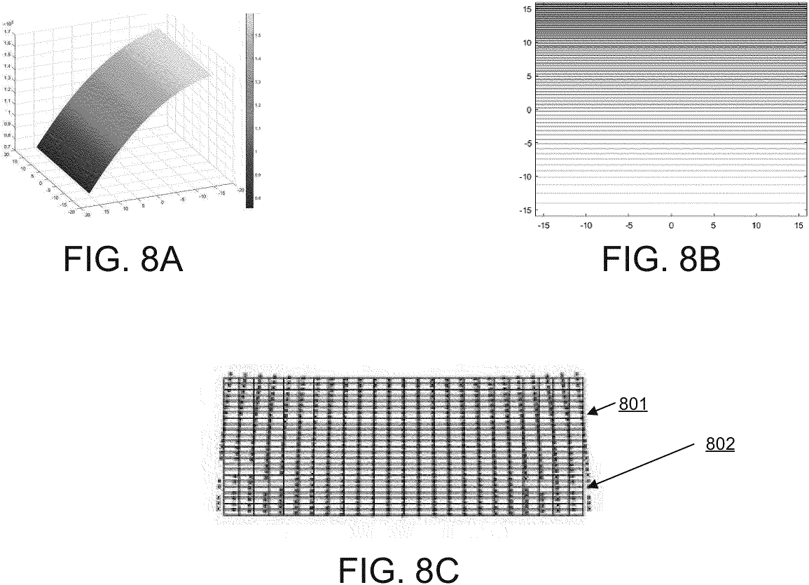

On the other hand, in some examples, a spatially located, free form optical component as described herein may implement a spherical, cylindrical, aspheric, or free from curvature. That is, the spatially located, free form optical component may be implemented having a non-linear (i.e., curved) surface. FIGS. 8A-C illustrate aspects of a phase change profile for a curved holographic optical element (HOE). In some instances, and as illustrated in FIGS. 8A & 8B, the spatially located, free form optical component may implement a non-linear phase change, and may be evidenced by a non-linear gradient on a phase change profile.

In some examples, a spatially located, free form optical component having a curved phase profile may overcome the issues discussed above by bringing the projected image more in line with the actual image. Specifically, in some examples and as shown in FIG. 8C, where a spatially located, free form optical component may have and/or implement a curvature, an image 801 having a rectangular shape may project to a projected image 802 that may have a (similar) rectangular shape as well.

It should be appreciated that a degree of curvature associated with a spatially located, free form optical component as described may be selected and/or implemented to optimize image generation by an optical device. Accordingly, in some examples, a spatially located, free form optical component implemented in an optical device may provide increased image resolution and may correct distortion by balancing an aspect ratio on a vertical and horizontal plane of a generated image. Indeed, in some examples, implementation of an optimized phase profile via utilization of a spatially located, free form optical component having a curvature may be shown to improve overall distortion performance considerably (e.g., image distortion may reduce from -16.7% to ~ 4.4%). Furthermore, in some examples, a free form optical component (e.g., a curved phase plate) as described herein may be used to correct aberrations such as spherical aberration, coma, astigmatism and field curvature.

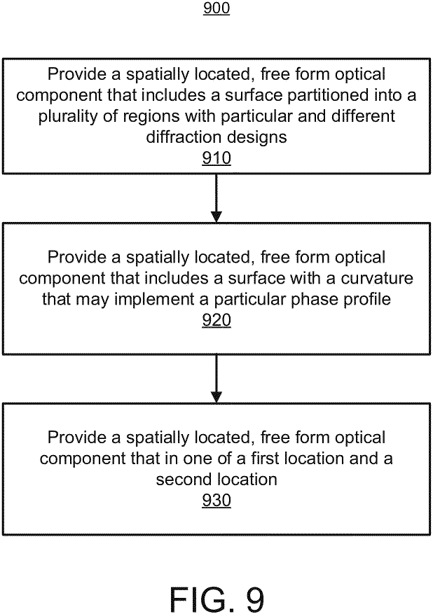

FIG. 9 illustrates a flow chart of a method for implementing a spatially located, free form optical component in an optical device for distortion compensation and clarity enhancement in an optical device. The method 900 is provided by way of example, as there may be a variety of ways to carry out the method described herein. Although the method 900 is primarily described as being performed by the system 100 of FIG. 1 and/or optical devices 400, 500 and 600 of FIGS. 4, 5A-C, and 6, the method 900 may be executed or otherwise performed by one or more processing components of another system or a combination of systems. Each block shown in FIG. 9 may further represent one or more processes, methods, or subroutines, and one or more of the blocks may include machine readable instructions stored on a non-transitory computer readable medium and executed by a processor or other type of processing circuit to perform one or more operations described herein.

At block 910, a spatially located, free form optical component may be provided, wherein the providing may include partitioning a surface of the spatially located, free form optical component into a plurality of regions with specific and particular diffraction designs. In some examples, each of these plurality of regions with specific and particular diffraction designs may reflect (or transmit) a plurality of “clustered” optical rays at multiple reflective (or transmissive) angles. In some examples, the plurality of regions may include four regions, where a first region may diffract red optical rays (i.e., a red cluster) at a first reflective angle, a second region may diffract yellow optical rays (i.e., a yellow cluster) at a second reflective angle, a third region 504c may diffract green optical rays (i.e., a green cluster) at a third reflective angle, and the fourth region 504d may diffract blue optical rays (i.e., a blue cluster) at a fourth reflective angle. As discussed above, each of the ray clusters emitted at a particular (i.e., unique) may enable an optical camera to function as a plurality of optical cameras and may enable enhanced tracking (e.g., of a user’s eyeball).

At block 920, a spatially located, free form optical component may be provided, wherein the providing may include a surface of the spatially located, free form optical component implement a (surface) curvature. In particular, in some examples, the spatially located, free form optical component may be implemented having a non-linear (i.e., curved) surface. In these instances, the spatially located, free form optical component may implement a non-linear phase change. As discussed above, in some examples, a curvature may be implemented that may enable a distortion (e.g., a Keystone distortion) to be compensated. In other examples, the spatially located, free form optical component may implement a linear (i.e., straight) surface as well.

At block 930, a spatially located, free form optical component may be spatially located at a location within an optical device. In some examples, the spatially located, free form optical component may be located at a first location, wherein the spatially located, free form optical component may be utilized as a transmissive element. Also, in some examples, the spatially located, free form optical component may be located in a second location, wherein the spatially located, free form optical component may be utilized as a reflector element.

It should be appreciated that the type of a spatially located, free form optical component may be configured as discussed above based at least in part on user preference, environmental conditions, or other parameter. In some examples, this may be achieved manually or automatically by a head-mounted display (HMD). For example, the head-mounted display (HMD) may include optoelectronic components that are capable to automatically detecting a user’s preferences, detect environmental conditions (e.g., using one or more sensors), and automatically adjusting the a spatially located, free form optical component as described in full or in part (e.g., zones). In this way, the head-mounted display (HMD) may automatically provide gazing accuracy, distortion reduction, and/or image sharpness enhancement without substantially increasing thickness of the overall optical assembly, adding additional optical components, or otherwise.

### Additional Information

The systems and methods described herein may provide a technique for distortion compensation and image clarity enhancement using compact imaging optics, which, for example, may be used in a head-mounted display (HMD) or other optical applications.

The benefits and advantages of the optical lens configurations described herein, may include, among other things, minimizing overall lens assembly thickness, reducing power consumption, increasing product flexibility and efficiency, and improved resolution. This may be achieved in any number of environments, such as in virtual reality (VR), augmented reality (AR), and/or mixed reality (MR) environments, or other optical scenarios.

As mentioned above, there may be numerous ways to configure, provide, manufacture, or position the various optical, electrical, and/or mechanical components or elements of the examples described above. While examples described herein are directed to certain configurations as shown, it should be appreciated that any of the components described or mentioned herein may be altered, changed, replaced, or modified, in size, shape, and numbers, or material, depending on application or use case, and adjusted for desired resolution or optimal results. In this way, other electrical, thermal, mechanical and/or design advantages may also be obtained.

It should be appreciated that the apparatuses, systems, and methods described herein may facilitate more desirable headsets or visual results. It should also be appreciated that the apparatuses, systems, and methods, as described herein, may also include or communicate with other components not shown. For example, these may include external processors, counters, analyzers, computing devices, and other measuring devices or systems. In some examples, this may also include middleware (not shown) as well. Middleware may include software hosted by one or more servers or devices. Furthermore, it should be appreciated that some of the middleware or servers may or may not be needed to achieve functionality. Other types of servers, middleware, systems, platforms, and applications not shown may also be provided at the back-end to facilitate the features and functionalities of the headset.

Moreover, single components described herein may be provided as multiple components, and vice versa, to perform the functions and features described above. It should be appreciated that the components of the apparatus or system described herein may operate in partial or full capacity, or it may be removed entirely. It should also be appreciated that analytics and processing techniques described herein with respect to the liquid crystal (LC) or optical configurations, for example, may also be performed partially or in full by these or other various components of the overall system or apparatus.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and/or interfaces, may be any number of optical, mechanical, electrical, hardware, network, or software components, circuits, elements, and interfaces that serves to facilitate communication, exchange, and analysis data between any number of or combination of equipment, protocol layers, or applications. For example, some of the components described herein may each include a network or communication interface to communicate with other servers, devices, components or network elements via a network or other communication protocol.

Although examples are generally directed to head-mounted displays (HMDs), it should be appreciated that the apparatuses, systems, and methods described herein may also be used in other various systems and other implementations. For example, these may include other various head-mounted systems, eyewear, wearable devices, optical systems, etc. in any number of virtual reality (VR), augmented reality (AR), and/or mixed reality (MR) environments, or beyond. In fact, there may be numerous applications in various optical or data communication scenarios, such as optical networking, image processing, etc.

It should be appreciated that the apparatuses, systems, and methods described herein may also be used to help provide, directly or indirectly, measurements for distance, angle, rotation, speed, position, wavelength, transmissivity, and/or other related optical measurements. For example, the systems and methods described herein may allow for a higher optical resolution and increased system functionality using an efficient and cost-effective design concept. With additional advantages that include higher resolution, lower number of optical elements, more efficient processing techniques, cost-effective configurations, and smaller or more compact form factor, the apparatuses, systems, and methods described herein may be beneficial in many original equipment manufacturer (OEM) applications, where they may be readily integrated into various and existing equipment, systems, instruments, or other systems and methods. The apparatuses, systems, and methods described herein may provide mechanical simplicity and adaptability to small or large headsets. Ultimately, the apparatuses, systems, and methods described herein may increase resolution, minimize adverse effects of traditional systems, and improve visual efficiencies.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims-and their equivalents-in which all terms are meant in their broadest reasonable sense unless otherwise indicated.

1. An optical assembly, comprising:
an optical stack comprising at least two optical elements; and
at least one spatially located, free form optical component between the at least two optical elements, wherein the spatially located, free form optical component provides distortion compensation and enhanced image clarity.

2. The optical assembly of claim 1, wherein the optical stack further comprises pancake optics.

3. The optical assembly of claim 1, wherein a surface of the spatially located, free form optical component is partitioned into a plurality of regions.

4. The optical assembly of claim 3, wherein each of the plurality of regions implements a unique diffraction design.

5. The optical assembly of claim 3, wherein each of the plurality of regions reflects an associated cluster of optical rays.

6. The optical assembly of claim 5, wherein each of the plurality of regions reflects the associated cluster of optical rays at a unique reflective angle.

7. The optical assembly of claim 3, wherein a first region of the plurality of regions reflects a cluster of red optical rays, a second region of the plurality of regions reflects a cluster of yellow optical rays, a third region of the plurality of regions reflects a cluster of green optical rays, and a fourth region of the plurality of regions reflects a cluster of blue optical rays.

8. The optical assembly of claim 1, wherein the spatially located, free form optical component is located at a transmissive location for use as a transmissive element.

9. The optical assembly of claim 1, wherein the spatially located, free form optical component is located at a reflecting location for use as a reflective element.

10. The optical assembly of claim 1, wherein the optical assembly is part of a head-mounted display (HMD) used in at least one of a virtual reality (VR), augmented reality (AR), or mixed reality (MR) environment.

11. A head-mounted display (HMD), comprising:
a display element to provide display light; and
an optical assembly to provide display light to a user of the head-mounted display (HMD), the optical assembly comprising:
an optical stack comprising at least two optical elements; and
at least one spatially located, free form optical component between the at least two optical elements, wherein the spatially located, free form optical component provides distortion compensation and enhanced image clarity.

12. The head-mounted display (HMD) of claim 11, wherein a surface of the spatially located, free form optical component is partitioned into a plurality of regions, and wherein each of the plurality of regions implements a unique diffraction design.

13. The head-mounted display (HMD) of claim 12, wherein each of the plurality of regions reflects an associated cluster of optical rays at a unique reflective angle.

14. The head-mounted display (HMD) of claim 11, wherein the optical assembly is part of a head-mounted display (HMD) used in at least one of a virtual reality (VR), augmented reality (AR), or mixed reality (MR) environment.

15. The head-mounted display (HMD) of claim 11, wherein the spatially located, free form optical component includes at least one curved surface having a curvature.

16. The head-mounted display (HMD) of claim 15, wherein the curvature of the at least one curved surface is associated with a particular phase profile.

17. The head-mounted display (HMD) of claim 11, wherein the spatially located, free form optical component is located at a transmissive location for use as a transmissive element.

18. The head-mounted display (HMD) of claim 11, wherein the spatially located, free form optical component is located at a reflective location for use as a reflective element.

19. A method for providing distortion compensation and enhanced image clarity in an optical assembly, comprising:
partitioning a surface of at least one spatially located, free form optical component into a plurality of regions each having a unique diffraction design;
providing a curvature with respect to the at least spatially located, free form optical component, wherein the curvature is associated with a particular phase profile; and
spatially locating the at least spatially located, free form optical component between two optical components of an optical assembly and in a location to one of transmit and reflect optical rays.

20. The method of claim 19, wherein the optical assembly is part of a head-mounted display (HMD) used in at least one of a virtual reality (VR), augmented reality (AR), or mixed reality (MR) environment.
